(19) United States
(12) Patent Application Publication
(10) Pub. No.: US 2016/0138903 A1
(43) Pub. Date: May 19, 2016

(54) TWO-DOF HETERODYNE GRATING INTERFEROMETER DISPLACEMENT MEASUREMENT SYSTEM

(71) Applicant: TSINGHUA UNIVERSITY, Beijing (CN)

(72) Inventors: Ming ZHANG, Beijing (CN); Yu ZHU, Beijing (CN); Leijie WANG, Beijing (CN); Kaiming YANG, Beijing (CN); Zhao LIU, Beijing (CN); Rong CHENG, Beijing (CN); Hao LIU, Beijing (CN); Dengfeng XU, Beijing (CN); Weinan YE, Beijing (CN); Li ZHANG, Beijing (CN); Yanpo ZHAO, Beijing (CN); Li TIAN, Beijing (CN); Jin ZHANG, Beijing (CN); Jinchun HU, Beijing (CN); Haihua MU, Beijing (CN); Wensheng YIN, Beijing (CN); Huichao QIN, Beijing (CN)

(73) Assignee: TSINGHUA UNIVERSITY, Beijing (CN)

(21) Appl. No.: 14/900,121

(22) PCT Filed: Jun. 5, 2014
(86) PCT No.: PCT/CN2014/079223

§ 371 Date: Dec. 18, 2015

(30) Foreign Application Priority Data
Jun. 19, 2013 (CN) 201310243113.X

(51) Int. Cl. G01B 9/02; G01B 11/14

(52) U.S. Cl. CPC G01B 9/02007; G01B 11/14

(57) ABSTRACT

A two-DOF heterodyne grating interferometer displacement measurement system, comprising a dual-frequency laser, a grating interferometer, a measurement grating, receivers and an electronic signal processing component, wherein the grating interferometer comprises a polarizing spectroscope, a reference grating and dioptric elements. The measurement system achieves the displacement measurement on the basis of the grating diffraction, the optical Doppler effect and the optical beat frequency principle. When the grating interferometer and the measurement grating conduct two-DOF linear relative motion, the system can output two linear displacements. The measurement system can achieve sub-nanometer or even higher resolution and accuracy, and can simultaneously measure two linear displacements. The measurement system has the advantages of insensitivity to the environment, high measurement accuracy, a small volume and light weight, and can improve the comprehensive performance of a workpiece stage as a position measurement system for an ultra-precise workpiece stage of a photoetching machine.

### TECHNICAL FIELD OF THE INVENTION

The present invention relates to a grating measurement system, in particular to a two-DOF (degree of freedom) heterodyne grating interferometer measurement system for displacement measurement of a workpiece stage of a photoetching machine.

### BACKGROUND OF THE INVENTION

The grating measurement system as a typical displacement sensor is widely applied to many mechanical and electrical equipment. The measuring principle of the grating measurement system is mainly based on the principle of Moire fringe and the principle of diffraction and interference. The grating measurement system based on the principle of Moire fringe is a mature displacement sensor having become the first choice of displacement measurement for many mechanical and electrical equipment due to its numerous advantages such as long ranging, low cost, easy alignment, etc., but its accuracy is usually at the micron scale, and it is commonly seen in general industrial applications.

In semiconductor manufacturing equipment, a photoetching machine is the key equipment in the manufacture of semiconductor chips. An ultra-precise workpiece stage is the core subsystem of the photoetching machine, and is used for carrying mask plates and silicon wafers to implement high-speed ultra-precision stepping and scanning movement. The ultra-precise workpiece stage becomes the most typical system in ultra-precise movement systems due to its movement characteristics, such as high-speed, high acceleration, large stroke, ultra-precision, and multi-DOF, etc. In order to achieve the above movements, the ultra-precision workpiece stage usually adopts a dual-frequency laser interferometer measurement system to measure multi-DOF displacements of the ultra-precision workpiece stage. However, as the continuous improvement of such movement indicators as measurement accuracy, measurement distance, measurement speed, etc., the dual-frequency laser interferometer is difficult to meet higher measurement demands due to a series of existing problems, such as environmental sensitivity, difficulties in improving measurement speed, large space occupation, expensive price, poor in measuring the dynamic characteristics of the target work stage, etc.

With respect to the above-mentioned problems, major companies and research institutions in the field of ultra-precision measurement all around the world launched a series of researches, concentrating mainly on grating measurement system based on the principle of diffraction and interference, and the research results are disclosed in many patents and papers.

U.S. Pat. No. 7,102,729 B2 (publication date: Aug. 4, 2005), U.S. Pat. No. 7,483,120 B2 (publication date: Nov. 15, 2007), U.S. Pat. No. 7,940,392 B2 (publication date: Dec. 24, 2009), and Publication No. US2010/0321665 A1 (publication date: Dec. 23, 2010) disclose a plane grating measurement system applied to a ultra-precision workpiece stage of a photoetching machine and its arrangement scheme, where the measurement system mainly uses an one-dimensional or two-dimensional plane grating coordinating with a reading head so as to measure large stroke horizontal displacement of the workpiece stage; and adopts a sensor, such as an eddy current sensor or an interferometer, etc., to measure vertical displacement, but the application of a variety of sensors limits the measurement accuracy of the workpiece stage. U.S. Patent Document Publication No. US2011/0255096 A1 (publication date: Oct. 20, 2011) discloses a grating measurement system applied to a ultra-precision workpiece stage of a photoetching machine, where the measurement system also uses an one-dimensional or two-dimensional grating coordinating with a particular reading head so as to implement displacement measurement and can conduct horizontal and vertical displacement measurements simultaneously, but its structure is complicated. U.S. Patent Document Publication No. US2011/0096334 A1 (publication date: Apr. 28, 2011) discloses a heterodyne interferometer, where the interferometer adopts a grating as the target mirror, but the interferometer can only implement one dimensional measurement. Japanese scholar GAOWEI presents a single-frequency two-dimensional grating measurement system, which utilizes the principle of diffraction and interference, in research paper “Design and construction of a two-degree-of-freedom linear encoder for nanometric measurement of stage position and straightness. Precision Engineering 34(2010)145-155”, where the grating measurement system can implement horizontal and vertical displacement measurements simultaneously, but due to the adoption of the single frequency laser light, the measurement signal is susceptible to interference, and accuracy is difficult to be guaranteed. Chinese patent literature Application No. 201210449244.9 (filling date: Nov. 9, 2012) and 201210448734.7 (filling date: Nov. 9, 2012) respectively disclose a heterodyne grating interferometer measurement system, where both the interferometer measurement systems adopt, in their reading head structures, quarter waveplates to change the polarization state of light beam, the optical structure is complex, while the non-ideal properties of the optical element will result in measurement errors.

### SUMMARY OF THE INVENTION

In view of the limitations of the above-mentioned technical solution, there is sought a heterodyne grating interferometer measurement system which utilizes the principle of optical beat frequency. The measurement system can implement simultaneous measurements of two-linear-DOF displacements. The measurement system features a short measurement light path, a low environmental sensitivity, an easy-to-process measurement signal, and a resolution and accuracy reaching up to the subnanometer scale or even higher. Meanwhile, the grating interferometer measurement system also features such advantages as a simple structure, a small volume, a light weight, being easy to install, and being convenient to apply, etc. By adopting the measurement system as a displacement measuring device for ultra-precise workpiece stage, it can effectively reduce the disadvantages in the application of the laser interferometer measurement system to the ultra-precise workpiece stage, enhancing the performance of the ultra-precise workpiece stage of a photoetching machine. The two-DOF heterodyne grating interferometer displacement measurement system can also be applied to the precise measurement of multi-DOF displacements of the workpiece stage of precision machine tools, three-coordinate measuring machines, and semiconductor testing equipments, etc.

The technical solution of the present invention is as follows:

A two-DOF heterodyne grating interferometer displacement measurement system, characterized in that it comprises a dual-frequency laser, a grating interferometer, a measurement grating, two receivers and an electronic signal processing component; wherein the grating interferometer comprises a polarizing spectroscope, a reference grating, a first dioptric element and a second dioptric element; the dual-frequency laser emits dual-frequency orthogonal polarized laser light which is split into transmitted light and reflected light after being incident onto the polarizing spectroscope through optical fiber coupling, wherein the transmitted light is reference light, and the reflected light is measurement light;

after the reference light is incident onto the reference grating, two beams of diffracted and reflected reference light are generated, and the two beams of diffracted and reflected reference light are deflected through the first dioptric element to form two beams of parallel reference light, which return to the polarizing spectroscope and transmit therethrough;

after the measurement light is incident onto the measurement grating, two beams of diffracted and reflected measurement light are generated, and the two beams of diffracted and reflected measurement light are deflected through the second dioptric element to form two beams of parallel measurement light, which return to the polarizing spectroscope and are reflected by the polarizing spectroscope;

wherein, a beam of transmitted reference light and a beam of reflected measurement light are incorporated with each other to form a path of measurement optical signal, and another beam of transmitted reference light and another beam of reflected measurement light are incorporated with each other to form another path of measurement optical signal, the two paths of measurement optical signals are transmitted to the two receivers through optical fibers to be processed so as to form two paths of measurement electrical signals, respectively, and the two paths of measurement electrical signals are transmitted to the electronic signal processing component to be processed; and

meantime, the dual-frequency laser also outputs a beam of reference electrical signal to the electronic signal processing component; when the measurement grating conducts two-DOF linear movements, i.e., movements in horizontal direction and vertical direction, with respect to the grating interferometer, the electronic signal processing component outputs two-DOF linear displacements.

In the above technical solution, each of the reference grating and the measurement grating adopts one-dimensional reflection grating, and each of the first dioptric element and the second dioptric element is composed of two right angle prisms which are arranged in parallel.

Another technical solution of the present invention is that: each of the first dioptric element and the second dioptric element is composed of two mirrors.

Another technical solution of the present invention is that: each of the first dioptric element and the second dioptric element adopts a dioptric prism whose cross-sectional shape is an isosceles trapezoid.

A preferred technical solution of the present invention is that: each of the first dioptric element and the second dioptric element adopts a lens.

Another preferred technical solution of the present invention is that: the two receivers and the electronic signal processing component are integrated into an integral structure, wherein, the two paths of measurement optical signals and a path of reference electrical signal output from the dual-frequency laser are input to the integral structure to be processed, and then the displacements of the two-DOF linear movements, i.e., movements in horizontal direction and vertical direction, are output.

The two-DOF heterodyne grating interferometer displacement measurement system provided by the present invention features the following advantages and prominent effects.

The measurement system can implement simultaneous measurements of two-DOF linear displacements. The measurement system features a short measurement light path, a low environmental sensitivity, an easy-to-process measurement signal, and a resolution and accuracy reaching up to the subnanometer scale or even higher. Meanwhile, the grating interferometer measurement system also features such advantages as a simple structure, a small volume, a light weight, being easy to install, and being convenient to apply, etc. Compared to a laser interferometer measurement system, the measurement system of the present invention applied to the displacement measurement of the ultra-precise workpiece stage of a photoetching machine can, based on meeting measurement demands, effectively reduce the volume and weight of the workpiece stage, greatly enhance dynamic performance of the workpiece stage, and make the whole performance of the workpiece stage be enhanced comprehensively. The two-DOF heterodyne grating interferometer displacement measurement system can also be applied to the precise measurement of multi-DOF displacements of the workpiece stage of precision machine tools, three-coordinate measuring machines, and semiconductor testing equipment, etc.

### BRIEF DESCRIPTION OF THE DRAWINGS

FIG. 1 is a schematic diagram of the first kind of heterodyne grating interferometer displacement measurement system of the present invention.

FIG. 2 is a schematic diagram of the internal structure of the first kind of grating interferometer of the present invention.

FIG. 3 is a schematic diagram of a second kind of heterodyne grating interferometer displacement measurement system of the present invention.

FIG. 4 is a schematic diagram of the internal structure of the second kind of grating interferometer of the present invention.

FIG. 5 is a schematic diagram of the internal structure of the third kind of grating interferometer of the present invention.

FIG. 6 is a schematic diagram of the internal structure of the fourth kind of grating interferometer of the present invention.

The reference numbers in the drawings comprise: 1—dual-frequency laser; 2—grating interferometer; 3—measurement grating; 4—receiver; 5—electronic signal processing component; 6—integral structure; 21—polarizing spectroscope; 22—reference grating; 23a—right angle prism; 23b—mirror; 23c—dioptric prism; 23d—lens.

### DETAILED DESCRIPTION OF EMBODIMENTS OF THE INVENTION

Hereinafter, the structure, principle and specific implementing mode of the present invention will be further detailed in connection with the accompanying drawings.

With reference to FIG. 1, FIG. 1 is a schematic diagram of the first kind of heterodyne grating interferometer displacement measurement system of the present invention. As shown in FIG. 1, the two-DOF heterodyne grating interferometer displacement measurement system comprises a dual-frequency laser 1, a grating interferometer 2, a measurement grating 3, receivers 4 and an electronic signal processing component 5, and the measurement grating 3 is an one-dimensional reflection grating.

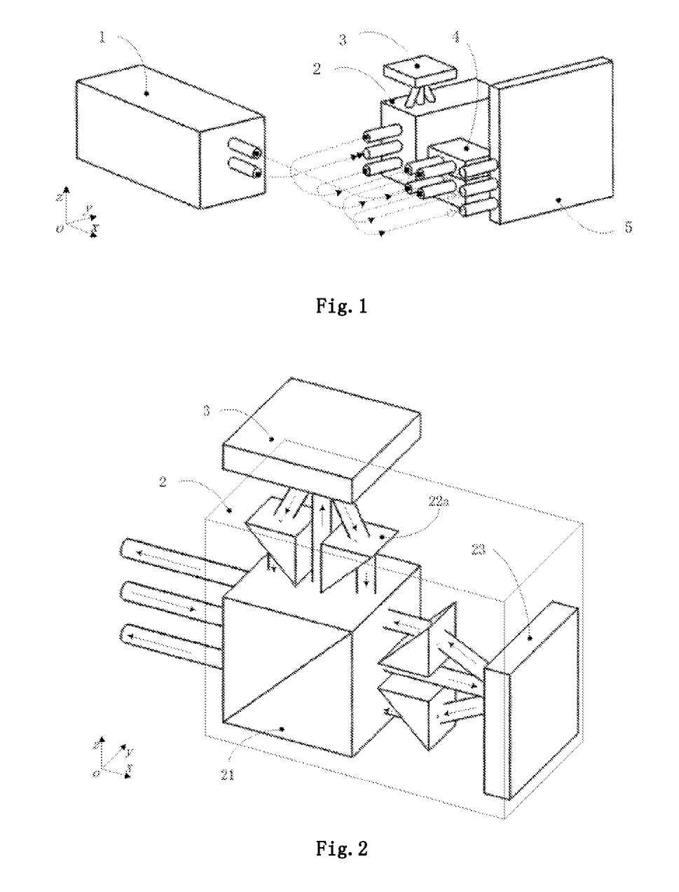

With reference to FIG. 2, FIG. 2 is a schematic diagram of the internal structure of the first kind of grating interferometer of the present invention. The grating interferometer 2 comprises a polarizing spectroscope 21, a reference grating 22, a first dioptric element and a second dioptric element; the reference grating 22 is an one-dimensional reflection grating; and, each of the first dioptric element and the second dioptric element is composed of two right angle prisms 23a which are arranged in parallel.

The principle of the measurement system will be described in conjunction with FIG. 1 and FIG. 2. The dual-frequency laser 1 emits dual-frequency orthogonal polarized laser light which is split into transmitted light and reflected light after being incident onto the polarizing spectroscope 21 through optical fiber coupling, wherein the transmitted light is reference light, and the reflected light is measurement light.

After the reference light is incident onto the reference grating 22, two beams of diffracted and reflected reference light are generated, and the two beams of diffracted and reflected reference light are respectively deflected through the two right angle prisms 23a to form two beams of parallel reference light, which return to the polarizing spectroscope 21 and transmit therethrough.

After the measurement light is incident onto the measurement grating 3, two beams of diffracted and reflected measurement light are generated, and the two beams of diffracted and reflected measurement light are respectively deflected through the two right angle prisms 23a to form two beams of parallel measurement light, which return to the polarizing spectroscope 21 and are reflected by the polarizing spectroscope.

Wherein, a beam of transmitted reference light and a beam of reflected measurement light are incorporated with each other to form a path of measurement optical signal, and another beam of transmitted reference light and another beam of reflected measurement light are incorporated with each other to form another path of measurement optical signal, the two paths of measurement optical signals are transmitted to the two receivers 4 through optical fibers to be processed so as to form two paths of measurement electrical signals, respectively, and the two paths of measurement electrical signals are transmitted to the electronic signal processing component 5 to be processed.

Meantime, the dual-frequency laser 1 also outputs a beam of reference electrical signal to the electronic signal processing component 5; when the measurement grating 3 conducts two-DOF linear movements, i.e., movements in horizontal direction and vertical direction (the movement in vertical direction is a minute movement, where the movement range is 1 mm), with respect to the grating interferometer 2, the electronic signal processing component 5 outputs two-DOF linear displacements.

The expressions of the displacements of the two-DOF movements are: x=kₓ×(α−β), z=k_{z}×(α+β), kₓ=Λ/4π, k_{z}=λ/4(1+cos θ), where α and β are the reading values of an electronic signal processing card, Λ is the grating constant, λ is the wavelength of the laser light, θ is the grating diffraction angle, taking Λ=1 μm, λ=632.8 nm, the phase resolution of α and β is 2π/1024, the measurement resolution of x and z of the heterodyne grating interferometer are 0.49 nm and 0.18 nm, respectively.

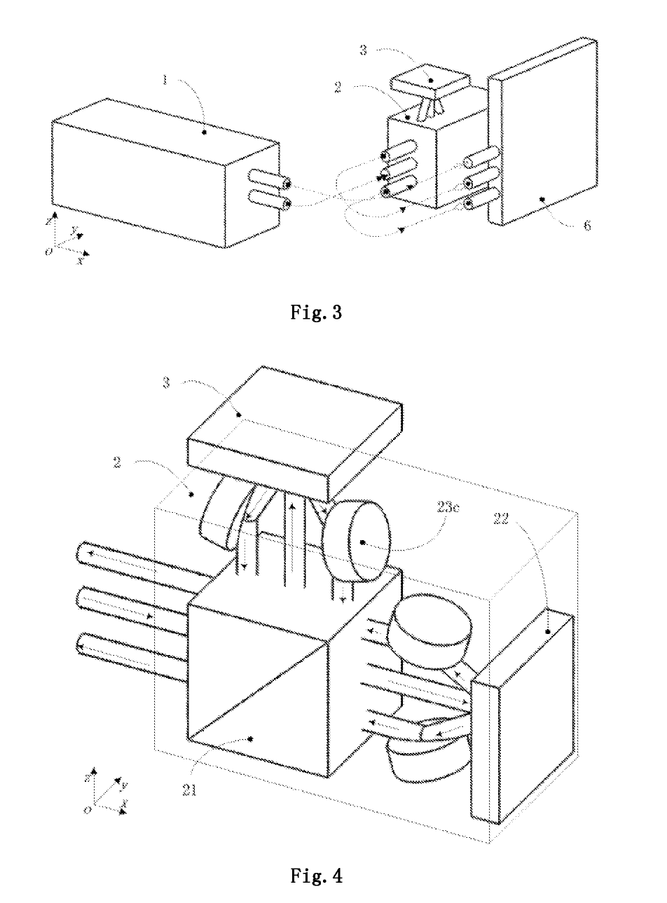

With reference to FIG. 3, FIG. 3 is a schematic diagram of the second kind of heterodyne grating interferometer displacement measurement system of the present invention. As shown in FIG. 3, the two receivers and the electronic signal processing component 5 are integrated into an integral structure 6, wherein, the two paths of measurement optical signals and a path of reference electrical signal output from the dual-frequency laser are input to the integral structure 6 to be processed, and then the displacements of two-DOF linear movements, i.e., movements in horizontal direction and vertical direction, are output. The adoption of this kind of integral structure 6 of the measurement system can effectively reduce the number of systematic components, improve anti jamming capability of the system, and improve system integration.

With reference to FIG. 4, FIG. 4 is a schematic diagram of the internal structure of the second kind of grating interferometer of the present invention. In the internal structure of the grating interferometer, as shown in FIG. 4, each of the first dioptric element and the second dioptric element is composed of two mirrors 23b. Compared to the scheme adopting the right angle prisms 23a, this scheme can eliminate measurement nonlinearity caused by beam passing through the right angle prism, but the installation of the mirror occupies more space.

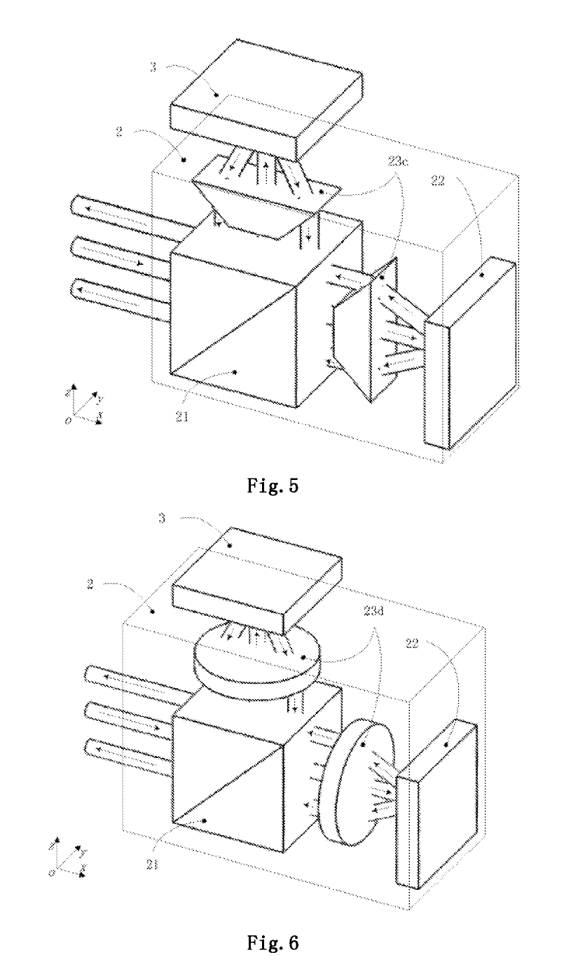

With reference to FIG. 5, FIG. 5 is a schematic diagram of the internal structure of the third kind of grating interferometer of the present invention. In the internal structure of the grating interferometer, as shown in FIG. 5, each of the first dioptric element and the second dioptric element adopts a dioptric prism 23c whose cross-sectional shape is an isosceles trapezoid. The dioptric prism 23c integrate a set of right angle prisms 23a, thus having such advantages as simple structure and being easy to install, etc.

With reference to FIG. 6, FIG. 6 is a schematic diagram of the internal structure of the fourth kind of grating interferometer of the present invention. In the internal structure of the grating interferometer, as shown in FIG. 6, each of the first dioptric element and the second dioptric element adopts a lens 23d to implement beam deflection. Compared to the dioptric prism 23c, the adoption of the lens 23d occupies a small space, which can make the structure of the interferometer more compact, simple and being easy to install.

The measurement system and structure scheme described in the above embodiments can implement simultaneous measurements of two-linear-DOF displacements, and the measurement system features a short measurement light path, a low environmental sensitivity, an easy-to-process measurement signal, and a resolution and accuracy reaching up to the subnanometer scale or even higher. Meanwhile, the grating interferometer measurement system also features such advantages as a simple structure, a small volume, a light weight, being easy to install, and being convenient to apply, etc. Compared to a laser interferometer measurement system, the measurement system of the present invention applied to the displacement measurement of the ultra-precise workpiece stage of a photoetching machine can, based on meeting measurement demands, effectively reduce the volume and weight of the workpiece stage, greatly enhance dynamic performance of the workpiece stage, and make the whole performance of the workpiece stage be enhanced comprehensively. The two-DOF heterodyne grating interferometer displacement measurement system can also be applied to the precise measurement of multi-DOF displacements of the workpiece stage of precision machine tools, three-coordinate measuring machines, and semiconductor testing equipment, etc.

1. A two-DOF heterodyne grating interferometer displacement measurement system, characterized in that it comprises a dual-frequency laser (1), a grating interferometer (2), a measurement grating (3), two receivers (4) and an electronic signal processing component (5); wherein the grating interferometer (2) comprises a polarizing spectroscope (21), a reference grating (22), a first dioptric element and a second dioptric element; the dual-frequency laser (1) emits a dual-frequency orthogonal polarized laser light which is split into a transmitted light and a reflected light after being incident onto the polarizing spectroscope (21) through optical fiber coupling, wherein the transmitted light is a reference light, and the reflected light is a measurement light;
after the reference light is incident onto the reference grating (22), two beams of diffracted and reflected reference light are generated, and the two beams of diffracted and reflected reference light are deflected through the first dioptric element to form two beams of parallel reference light, which return to the polarizing spectroscope (21) and transmit therethrough;
after the measurement light is incident onto the measurement grating (3), two beams of diffracted and reflected measurement light are generated, and the two beams of diffracted and reflected measurement light are deflected through the second dioptric element to form two beams of parallel measurement light, which return to the polarizing spectroscope (21) and are reflected by the polarizing spectroscope (21);
wherein, a beam of transmitted reference light and a beam of reflected measurement light are incorporated with each other to form a path of measurement optical signal, and another beam of transmitted reference light and another beam of reflected measurement light are incorporated with each other to form another path of measurement optical signal, two paths of measurement optical signals are transmitted to the two receivers (4) through optical fibers to be processed so as to form two paths of measurement electrical signals, respectively, and the two paths of measurement electrical signals are transmitted to the electronic signal processing component (5) to be processed; and
meantime, the dual-frequency laser (1) also outputs a beam of reference electrical signal to the electronic signal processing component (5); when the measurement grating (3) conducts two-DOF linear movements, i.e., movements in horizontal direction and vertical direction, with respect to the grating interferometer (2), the electronic signal processing component (5) outputs two-DOF linear displacements.

2. The two-DOF heterodyne grating interferometer displacement measurement system according to claim 1, characterized in that each of the reference grating (22) and the measurement grating (3) adopts a one-dimensional reflection grating.

3. The two-DOF heterodyne grating interferometer displacement measurement system according to claim 1, characterized in that each of the first dioptric element and the second dioptric element is composed of two right angle prisms (23a) which are arranged in parallel.

4. The two-DOF heterodyne grating interferometer displacement measurement system according to claim 1, characterized in that each of the first dioptric element and the second dioptric element is composed of two mirrors (23b).

5. The two-DOF heterodyne grating interferometer displacement measurement system according to claim 1, characterized in that each of the first dioptric element and the second dioptric element adopts a dioptric prism (23c) whose cross-sectional shape is an isosceles trapezoid.

6. The two-DOF heterodyne grating interferometer displacement measurement system according to claim 1, characterized in that each of the first dioptric element and the second dioptric element adopts a lens (23d).

7. The two-DOF heterodyne grating interferometer displacement measurement system according to claim 1, characterized in that the two receivers and the electronic signal processing component (5) are integrated into an integral structure (6), wherein, the two paths of measurement optical signals and a path of reference electrical signal output from the dual-frequency laser are input to the integral structure (6) to be processed, and then the displacements of the two-DOF linear movements, i.e., movements in horizontal direction and vertical direction, are output.

8. The two-DOF heterodyne grating interferometer displacement measurement system according to claim 2, characterized in that the two receivers and the electronic signal processing component (5) are integrated into an integral structure (6), wherein, the two paths of measurement optical signals and a path of reference electrical signal output from the dual-frequency laser are input to the integral structure (6) to be processed, and then the displacements of the two-DOF linear movements, i.e., movements in horizontal direction and vertical direction, are output.

9. The two-DOF heterodyne grating interferometer displacement measurement system according to claim 3, characterized in that the two receivers and the electronic signal processing component (5) are integrated into an integral structure (6), wherein, the two paths of measurement optical signals and a path of reference electrical signal output from the dual-frequency laser are input to the integral structure (6) to be processed, and then the displacements of the two-DOF linear movements, i.e., movements in horizontal direction and vertical direction, are output.

10. The two-DOF heterodyne grating interferometer displacement measurement system according to claim 4, characterized in that the two receivers and the electronic signal processing component (5) are integrated into an integral structure (6), wherein, the two paths of measurement optical signals and a path of reference electrical signal output from the dual-frequency laser are input to the integral structure (6) to be processed, and then the displacements of the two-DOF linear movements, i.e., movements in horizontal direction and vertical direction, are output.

11. The two-DOF heterodyne grating interferometer displacement measurement system according to claim 5, characterized in that the two receivers and the electronic signal processing component (5) are integrated into an integral structure (6), wherein, the two paths of measurement optical signals and a path of reference electrical signal output from the dual-frequency laser are input to the integral structure (6) to be processed, and then the displacements of the two-DOF linear movements, i.e., movements in horizontal direction and vertical direction, are output.

12. The two-DOF heterodyne grating interferometer displacement measurement system according to claim 6, characterized in that the two receivers and the electronic signal processing component (5) are integrated into an integral structure (6), wherein, the two paths of measurement optical signals and a path of reference electrical signal output from the dual-frequency laser are input to the integral structure (6) to be processed, and then the displacements of the two-DOF linear movements, i.e., movements in horizontal direction and vertical direction, are output.
